(19) United States
(12) Patent Application Publication
(10) Pub. No.: US 2021/0216597 A1
(43) Pub. Date: Jul. 15, 2021

(54) METHOD AND APPARATUS FOR PROCESSING MINI APP MATERIAL, ELECTRONIC DEVICE AND MEDIUM

(71) Applicant: BEIJING BAIDU NETCOM SCIENCE AND TECHNOLOGY CO., LTD., Beijing (CN)

(72) Inventors: Xiaodong LI, Beijing (CN); Jin JIN, Beijing (CN); Nan LI, Beijing (CN); Malin XIE, Beijing (CN); Linfeng JI, Beijing (CN)

(21) Appl. No.: 17/219,281

(22) Filed: Mar. 31, 2021

Related U.S. Application Data
(63) Continuation of application No. PCT/CN2020/102923, filed on Jul. 29, 2020.

(30) Foreign Application Priority Data
Feb. 19, 2020 (CN) 202010100979.5

(51) Int. Cl. G06F 16/951; G06F 16/958; G06F 9/448

(52) U.S. Cl. CPC G06F 16/951; G06F 9/4484; G06F 16/958

(57) ABSTRACT

The present disclosure provides a method and apparatus for processing a mini app material, an electronic device and a medium. The method may include: detecting whether a mini app page is jumped to a new page of a business party of a mini app, during operation of the mini app; and if yes, extracting a material content of the new page based on a material extraction rule of the mini app, for as a new material content of the mini app.

### CROSS-REFERENCE TO RELATED APPLICATIONS

This application is a continuation of International Application No. PCT/CN2020/102923, filed on Jul. 20, 2020, which claims priority to Chinese Patent Application No. 202010100979.5, filed on Feb. 19, 2020, both of which are hereby incorporated by reference in their entireties.

### TECHNICAL FIELD

Embodiments of the present disclosure relate to the field of computer technology, for example, relate to data processing technology, and in particular to a method and apparatus for processing a mini app material, an electronic device and a medium.

### BACKGROUND

Mini app material content includes content title, description, picture link, tag, video link, etc., may be used to describe basic information of a mini app landing page. At present, a method for acquiring a mini app material content is that a developer takes the initiative to submit material content. However, a mini app includes at least hundreds or thousands of material content, and as many as tens of millions of material content. The workload for acquiring and submitting the material content is large and the efficiency is low.

### SUMMARY

The following is a summary of the topic described in detail in this disclosure. This summary is not intended to limit the scope of protection of the claims.

Embodiments of the present disclosure provide a method and apparatus for processing a mini app material, an electronic device and a medium.

An embodiment of the present disclosure provides a method for processing a mini app material. The method includes: detecting whether a mini app page is jumped to a new page of a business party of a mini app, during operation of the mini app; and in response to the mini app page being jumped to the new page of the business party of the mini app, extracting a material content of the new page based on a material extraction rule of the mini app, for use as a new material content of the mini app.

Further, before the extracting a material content of the new page based on a material extraction rule of the mini app, the method further includes: acquiring a material extraction rule of the mini app from a server, when the mini app starts; and loading the acquired material extraction rule.

Further, the acquiring a material extraction rule of the mini app from a server, includes: acquiring the material extraction rule of the mini app from the server, based on a to-be-extracted material type and/or material extraction rule version information.

Further, the material content of the new page includes at least one of: a title of the new page, a description, a picture link, a tag, a video link, or interaction information.

Further, the extracting a material content of the new page based on a material extraction rule of the mini app, includes: extracting the material content of the new page based on the material extraction rule of the mini app, via an asynchronous thread.

Further, after extracting the material content of the new page, the method further includes: verifying the extracted material content to obtain a material content that meets a verification rule, based on the verification rule; and rating the material content that meets the verification rule, to push a material based on a rating result.

An embodiment of the present disclosure further providers an apparatus for processing a mini app material. The apparatus includes: a jump detection module, configured to detect whether a mini app page is jumped to a new page of a business party of a mini app, during operation of the mini app; and a new material content determination module, configured to extract a material content of the new page based on a material extraction rule of the mini app, for use as a new material content of the mini app, in response to the mini app page being jumped to the new page of the business party of the mini app.

Further, the apparatus further includes: a material extraction rule acquisition module, configured to acquire a material extraction rule of the mini app from a server, when the mini app starts; and a material extraction rule loading module, configured to load the acquired material extraction rule.

Further, the material extraction rule acquisition module is configured to: acquire the material extraction rule of the mini app from the server, based on a to-be-extracted material type and/or material extraction rule version information.

Further, the material content of the new page comprises at least one of: a title of the new page, a description, a picture link, a tag, a video link, or interaction information.

Further, the new material content determination module is configured to: extract the material content of the new page based on the material extraction rule of the mini app, via an asynchronous thread.

Further, the apparatus further includes: a verification module, configured to verify the extracted material content to obtain a material content that meets a verification rule, based on the verification rule; and a pushing module, configured to rate the material content that meets the verification rule, to push a material based on a rating result.

An embodiment of the present disclosure further providers an electronic device, including: at least one processor; and a memory communicatively connected to the at least one processor. The memory stores instructions executable by the at least one processor, and the instructions, when executed by the at least one processor, cause the at least one processor to perform the method according to any embodiment of the present disclosure.

An embodiment of the present disclosure further providers a non-transitory computer readable storage medium, storing computer instructions. The computer instructions are used to cause the computer to perform the method according to any embodiment of the present disclosure.

Other effects of the above alternative implementations will be described below in combination with embodiments. Other aspects may be understood after reading and understanding accompanying drawings and the detailed description.

### BRIEF DESCRIPTION OF THE DRAWINGS

The accompanying drawings are used to better understand the present disclosure and do not constitute a limitation to the present disclosure.

FIG. 1 is a schematic flowchart of a method for processing a app material according to an embodiment of the present disclosure;

FIG. 2 is a schematic diagram of mini app material extraction according to an embodiment of the present disclosure;

FIG. 3 is a schematic flowchart of another method for processing a mini app material according to an embodiment of the present disclosure;

FIG. 4 is a flowchart of mini app material processing implementation according to an embodiment of the present disclosure;

FIG. 5 is a schematic structural diagram of an apparatus for processing a mini app material according to an embodiment of the present disclosure; and

FIG. 6 is a block diagram of an electronic device suitable for implementing the method for processing a mini app material according to embodiments of the present disclosure.

### DETAILED DESCRIPTION OF EMBODIMENTS

The following describes example embodiments of the present disclosure with reference to accompanying drawings, which include various details of embodiments of the present disclosure to facilitate understanding, and should be regarded as merely examples. Therefore, those of ordinary skill in the art should realize that various changes and modifications may be made to the embodiments described herein without departing from the scope and spirit of the present disclosure. Likewise, for clarity and conciseness, descriptions of well-known functions and structures are omitted in the following description.

FIG. 1 is a schematic flowchart of a method for processing a mini app material according to an embodiment of the present disclosure. The present embodiment may be applied to automatic extraction of material content in a mini app. Typically, the present embodiment may be applied to extracting a material content of a new page when a user perform an operation to jump a currently browsed mini app page to the new page. The method for processing a mini app material disclosed in the present embodiment may be performed by an electronic device configured with a mini app host application, specifically may be performed by an apparatus for processing a mini app material, and the apparatus may be implemented by software and/or hardware. Referring to FIG. 1, the method for processing a mini app material provided in the present embodiment includes the following steps.

S110, detecting whether a mini app page is jumped to a new page of a business party of a mini app, during operation of the mini app.

The business party of the mini app may be a mini app holder. General host applications support a variety of mini apps, and different mini apps may belong to the same business party, or belong to different business parties. The business party of the mini app is the business party of material content of the mini app. For example, mobile Baidu as the host application supports iQiyi mini apps, then the business party of the mini app is iQiyi, and iQiyi provides material content for the Iqiyi mini apps. In addition to including page of existing material content, the mini app also includes a page link of the business party. A page entered through the page link is the new page of the business party of the mini app. The host application does not have material content of the new page.

Currently, the mini app material content is generally sorted and collected by a developer. Each mini app page corresponds to a piece of material. There are a large number of mini app pages, including hundreds or even tens of millions of pieces of material information. Therefore, for the developer, the workload of sorting and submitting the material is very large. Therefore, in an embodiment of the present disclosure, based on part of the material content submitted by the developer, more and more comprehensive material content is extracted automatically, thereby enriching the material content.

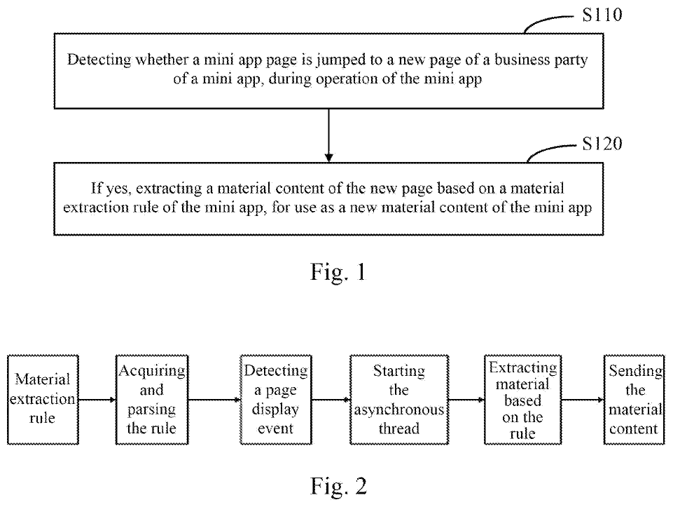

For example, as shown in FIG. 2, when the user browses a page of a mini app, he/she may need to view another page, so the user may click to jump to a new page of the business party of the mini app. The page browsed by the user may contain more user-interested content, have greater value, and is suitable for being pushed to more users for browsing. Therefore, it is detected whether the mini app page is jumped to the new page to determine whether it is necessary to extract the material content, that is, detect a page display event.

In an embodiment of the present disclosure, the detection of user behavior and the extraction of material may be performed by tools in a material extraction software development kit SDK in a terminal electronic device. The material extraction software development kit may be pre-configured in the electronic device. When the mini app operates, the material extraction SDK automatically detects whether the new page is jumped to by clicking by the user a recommended page in a currently displayed page of the mini app, to perform a subsequent operation when it is detected that the user browses the new page.

S120, in response to the mini app page being jumped to the new page of the business party of the mini app, extracting a material content of the new page based on a material extraction rule of the mini app, for use as a new material content of the mini app.

The embodiment of the present disclosure has the following advantages or beneficial effects: during the operation of the mini app, if the user browses the new page, the material content of the new page is extracted based on the material extraction rule of the mini app for use as the new material content, thereby overcoming the problem that the workload of artificial extraction of material content is large, the quantity of material content extracted is not comprehensive enough, and the quality is not high. It realizes automatically extraction of large quantity and high-quality mini app materials, and improving the effect of material extraction efficiency.

The material content of the new page includes at least one of: a title of the new page, a description, a picture link, a tag, a video link, or interaction information. The material extraction rule of the mini app may be a rule that specifies extracted concrete content of the mini app material, which may be determined based on the material content. For different types of mini app pages such as video, image-text, or questions and answers, the mini app pages correspond to different material extraction rules. For example, the material extraction rule of an image-text landing page may be title, description, picture link, comment, and likes, etc. The material extraction rule of a video landing page may be title, first picture link, video link, comment, and likes, etc. For a mini app page version, it may include a title tag, a body tag, a paragraph tag, a picture tag, a video tag, a comment tag, and a likes tag, etc. The material extraction rule may also be determined based on a component provided by APP in the terminal. For example, the APP provides a component for displaying video pages, a component for displaying image-text pages, and/or a component for displaying Q&A (Question and Answer) pages. The material extraction rule may be determined by the above types of pages.

For example, since there are various types of mini app pages, each type of page needs to display different content. For different types of pages, the types of extracted materials are also different. Therefore, in an embodiment of the present disclosure, different mini app material extraction rules are determined for different pages, and the material content of the new page is extracted based on the material extraction rule as the new material content of the mini app, so as to meet display requirements for different types of pages.

Based on the above, an embodiment of the present disclosure has the following advantages or beneficial effects: by extracting the material content of the new page including at least one of the title of the new page, the description, the picture link, the tag, the video link, or the interaction information, the extracted material content is more comprehensive and detailed, and meets the user's browsing requirements.

In an embodiment of the present embodiment, before the extracting a material content of the new page based on a material extraction rule of the mini app, the method further includes: acquiring a material extraction rule of the mini app from a server, when the mini app starts; and loading the acquired material extraction rule.

For example, the server may be the server of the mini app. As shown in FIG. 2, the material extraction rule is pre-stored in the server of the mini app. Before the material extraction SDK extracts the material content, the material extraction rule for a to-be-extracted material is acquired from the server, and the acquired material extraction rule is loaded in the material extraction SDK, to extract the material content in the new page of the mini app based on the material extraction rule, so that the extracted material content meets a display requirement for the page.

Based on the above, the embodiment of the present disclosure has the following advantages or beneficial effects: by determining the material extraction rule of the mini app, different types of material content are extracted based on corresponding different material extraction rules for different types of pages, thus meeting material content requirement standards for the different pages.

In an embodiment of the present embodiment, the acquiring a material extraction rule of the mini app from a server, includes: acquiring the material extraction rule of the mini app from the server, based on a to-be-extracted material type and/or material extraction rule version information.

For example, the to-be-extracted material type may include a video type, including materials such as long video and short video, image-text, Q&A, and live stream. When the user clicks to jump to the new page, the material type of the new page is determined, and for the material type, the pre-stored material extraction rule corresponding to the material type is acquired from the server. It may also be that the material extraction rule of the mini app is acquired from the server based on the to-be-extracted material extraction rule version information. Since version and page standards of the mini app may be updated and iterated constantly as the business develops, and at the same time business requirement standards for the material may change as the business changes, for the mini app page, the material content that needs to be extracted changes. Therefore, the material extraction rule version information in the server is updated in time, so that the material extraction rule version may be adjusted in time based on changes of the mini app version to meet a current page requirement standard. The material extraction SDK extracts the material extraction rule of the latest version from the server based on the material extraction version information to meet a current material content extraction requirement.

Based on the above, the embodiment of the present disclosure has the following advantages or beneficial effects: by acquiring the material extraction rule of the mini app from the server, based on the to-be-extracted material type and/or material extraction rule version information, information of a to-be-extracted material can be more specifically and accurately limited, facilitating targeted extracting the material that meets the material extraction rule in material extraction.

In an embodiment of the present disclosure, the extracting a material content of the new page based on a material extraction rule of the mini app, includes: extracting the material content of the new page based on the material extraction rule of the mini app, via an asynchronous thread.

For example, the extraction of the material content may be performed via the asynchronous thread, thereby improving the efficiency of material extraction. After the material content is extracted, the material content is sent for a subsequent operation step, such as further verification, rating, and storage.

Based on the above, the embodiment of the present disclosure has the following advantages or beneficial effects: by extracting the material content of the new page via the asynchronous thread, the efficiency of material extraction is improved.

The technical solution of the embodiments of the present disclosure reduces the workload of the developer for material extraction by automatically extracting mini app materials, improves the efficiency of material extraction, and extracts the material content of the new page based on the material extraction rule, thereby more comprehensively acquiring large quantity and high-quality materials, and further improving a subsequent distribution efficiency of the mini app.

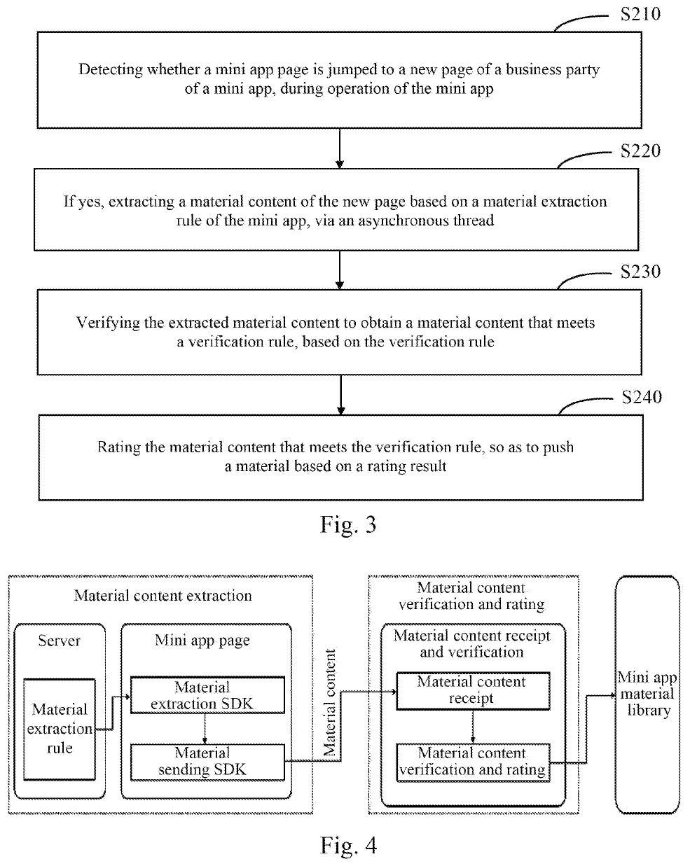

FIG. 3 is a schematic flowchart of another method for processing a mini app material according to an embodiment of the present disclosure. The present embodiment is an alternative solution proposed on the basis of the foregoing embodiments. Referring to FIG. 3, the method for processing a mini app material provided in the present embodiment includes the following steps.

S210, detecting whether a mini app page is jumped to a new page of a business party of a mini app, during operation of the mini app.

S220, if yes, extracting a material content of the new page based on a material extraction rule of the mini app, via an asynchronous thread.

S230, verifying the extracted material content to obtain a material content that meets a verification rule, based on the verification rule.

For example, as shown in FIG. 4, the extracted material content of the mini app may include content that is inappropriate to be pushed or content that does not comply with network information security, such as advertising content, and may also include content that cannot be displayed normally, such as a blank page, an invalid link, an unclear picture or other material content. Therefore, after the material content is extracted, the extracted material content may be verified, so as to screen out material content suitable to be pushed. The verification may include: first performing a basic verification on the material content, then detecting form of the material content to initially judge quality of the material content. For example, if it is detected that the title or description in the material content is empty, or a length is less than a preset character length, the material content is marked as a low-quality material and the verification fails. For a material that fails the verification, rating analysis may be directly performed on the material. If the basic verification approves, an advanced verification is performed on the material content to verify whether content of the material meets a standards or requirement. For different types of material content, different material verification strategies may be formulated, and the material verification strategies may be updated and changed based on actual situations. For example, for a picture link content of image-text material, the verification strategy may be: detecting whether the content includes advertising, etc. For a material that passes the advanced verification, rating analysis is performed.

S240, rating the material content that meets the verification rule, so as to push a material based on a rating result.

In an embodiment of the present embodiment, rating analysis may also be performed on the material content to determine quality of the material content. For example, a classification strategy may be customized, for example, the material content may be divided into high-quality material, medium-high-quality material and low-quality material, where the high-quality material may be material that passes both the basic verification and the advanced verification. The low-quality material may be material content that does not pass the basic verification, or material content that pass the basic verification but fail the advanced verification. Other material content may be classified as the medium-high-quality material content. Classified material content is stored to a material library to facilitate subsequent material distribution. Rating can more directly show the quality of the material content, so that it is convenient to select material content of higher quality to push, so that the user can browse normally, the user's browsing tendency is met, and the distribution efficiency of the mini app is improved.

In this embodiment of the present disclosure, the material content is verified and rating analysis is performed to detect the content of the material to determine the quality of the material content, and screen out high-quality material content to push to the user. In addition, due to the automatic completion of material extraction and verification and rating, the distribution efficiency of material extraction is improved. While ensuring abundant quantity of the material, the quality of the pushed material is also improved, thereby increasing page views and traffic acquisitions of the mini app page.

Based on the above, the embodiment of the present disclosure has the following advantages or beneficial effects: by verifying the extracted material content, and rating the material content that meets the verification rule then pushing, high quality of the pushed material content is guaranteed, avoiding the pushed material content including a blank page, an invalid link, an unclear picture, etc.

FIG. 5 is a schematic structural diagram of an apparatus for processing a mini app material according to an embodiment of the present disclosure. Referring to FIG. 5, an embodiment of the present disclosure discloses an apparatus 300 for processing a mini app material, and the apparatus 300 includes: a jump detection module 301 and a new material content determination module 302.

The jump detection module 301 is configured to detect whether a mini app page is jumped to a new page of a business party of a mini app, during operation of the mini app.

The new material content determination module 302 is configured to extract a material content of the new page based on a material extraction rule of the mini app, for use as a new material content of the mini app, in response to that the mini app page is jumped to the new page of the business party of the mini app.

In an embodiment, the apparatus further includes: a material extraction rule acquisition module, configured to acquire a material extraction rule of the mini app from a server, when a mini app starts; and a material extraction rule loading module, configured to load the acquired material extraction rule.

In an embodiment, the material extraction rule acquisition module is specifically configured to: acquire the material extraction rule of the mini app from the server, based on a to-be-extracted material type and/or material extraction rule version information.

In an embodiment, the material content of the new page includes at least one of: a title of the new page, a description, a picture link, a tag, a video link, or interaction information.

In an embodiment, the new material content determination module 302 is specifically configured to: extract the material content of the new page based on the material extraction rule of the mini app, via an asynchronous thread.

In an embodiment, the apparatus further includes: a verification module, configured to verify the extracted material content to obtain a material content that meets a verification rule, based on the verification rule; and a pushing module, configured to rate the material content that meets the verification rule, to push a material based on a rating result.

The apparatus for processing a mini app material provided in this embodiment of the present disclosure may perform the method for processing a mini app material provided in any embodiment of the present disclosure, and has the corresponding functional modules and beneficial effects for performing the method.

According to an embodiment of the present disclosure, the present disclosure further provides an electronic device and a readable storage medium.

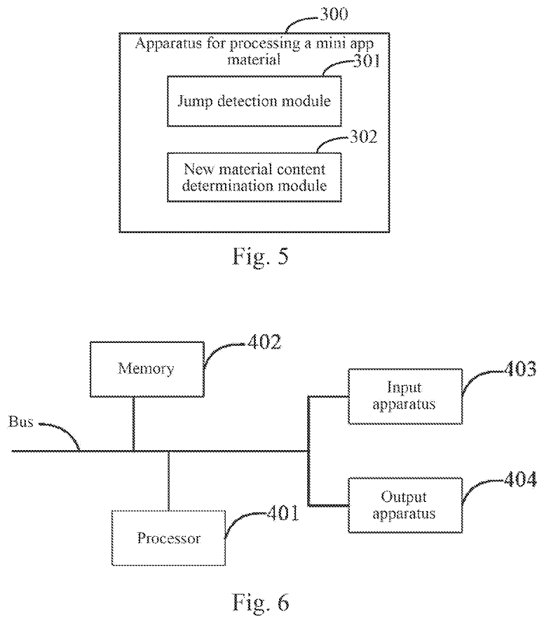

As shown in FIG. 6, FIG. 6 is a block diagram of an electronic device for implementing the method for processing a mini app material according to an embodiment of the present disclosure. The electronic device is intended to represent various forms of digital computers, such as laptop computers, desktop computers, workbenches, personal digital assistants, electronic devices, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, the electronic device includes: one or more processors 401, a memory 402, and interfaces for connecting various components, including high-speed interfaces and low-speed interfaces. The various components are connected to each other using different buses, and may be installed on a common motherboard or in other methods as needed. The processor may process instructions executed within the electronic device, including instructions stored in or on the memory to display graphic information of GUI on an external input/output apparatus (such as a display device coupled to the interface). In other embodiments, a plurality of processors and/or a plurality of buses may be used together with a plurality of memories and a plurality of memories if desired. Similarly, a plurality of electronic devices may be connected, and the devices provide some necessary operations, for example, as a server array, a set of blade servers, or a multi-processor system. In FIG. 6, one processor 401 is used as an example.

The memory 402 is a non-transitory computer readable storage medium provided by the present disclosure. The memory stores instructions executable by at least one processor, so that the at least one processor performs the method for processing a mini app material provided by the present disclosure. The non-transitory computer readable storage medium of the present disclosure stores computer instructions for causing a computer to perform the method for processing a mini app material provided by the present disclosure.

The memory 402, as a non-transitory computer readable storage medium, may be used to store non-transitory software programs, non-transitory computer executable programs and modules, such as program instructions/modules corresponding to the method for processing a mini app material in the embodiments of the present disclosure (for example, the jump detection module 301 and the new material content determination module 302 as shown in FIG. 5). The processor 401 executes the non-transitory software programs, instructions, and modules stored in the memory 402 to execute various functional applications and data processing of the electronic device, that is, to implement the method for processing a mini app material in the foregoing method embodiments.

The memory 402 may include a storage program area and a storage data area, where the storage program area may store an operating system and at least one function required application program; and the storage data area may store data created by the use of the electronic device for processing a mini app material. In addition, the memory 402 may include a high-speed random access memory, and may also include a non-transitory memory, such as at least one magnetic disk storage device, a flash memory device, or other non-transitory solid-state storage devices. In some embodiments, the memory 402 may optionally include memories remotely provided with respect to the processor 401, and these remote memories may be connected to the electronic device for processing a mini app material through a network. Examples of the above network include but are not limited to the Internet, intranet, local area network, mobile communication network, and combinations thereof.

The electronic device of the method for processing a mini app material may further include: an input apparatus 403 and an output apparatus 404. The processor 401, the memory 402, the input apparatus 403, and the output apparatus 404 may be connected through a bus or in other methods. In FIG. 6, connection through the bus is used as an example.

The input apparatus 603 may receive input digital or character information, and generate key signal inputs related to user settings and function control of the electronic device of the method for processing a mini app material, such as touch screen, keypad, mouse, trackpad, touchpad, pointing stick, one or more mouse buttons, trackball, joystick and other input apparatuses. The output apparatus 404 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, dedicated ASICs (application specific integrated circuits), computer hardware, firmware, software, and/or combinations thereof. These various embodiments may include: being implemented in one or more computer programs that can be executed and/or interpreted on a programmable system that includes at least one programmable processor. The programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

These computing programs (also referred to as programs, software, software applications, or codes) include machine instructions of the programmable processor and may use high-level processes and/or object-oriented programming languages, and/or assembly/machine languages to implement these computing programs. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

In order to provide interaction with a user, the systems and technologies described herein may be implemented on a computer, the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), the Internet, and blockchain networks.

The computer system may include a client and an electronic device. The client and the electronic device are generally far from each other and usually interact through the communication network. The relationship between the client and the electronic device is generated by computer programs that run on the corresponding computer and have a client-server relationship with each other.

It should be understood that the various forms of processes shown above may be used to reorder, add, or delete steps. For example, the steps described in the present disclosure may be performed in parallel, sequentially, or in different orders. As long as the desired results of the technical solution disclosed in the present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for processing a mini app material, the method comprising:
detecting whether a mini app page is jumped to a new page of a business party of a mini app, during operation of the mini app; and
in response to the mini app page being jumped to the new page of the business party of the mini app, extracting a material content of the new page based on a material extraction rule of the mini app, for use as a new material content of the mini app.

2. The method according to claim 1, wherein before the extracting a material content of the new page based on a material extraction rule of the mini app, the method further comprises:
acquiring a material extraction rule of the mini app from a server, when the mini app starts; and
loading the acquired material extraction rule.

3. The method according to claim 2, wherein the acquiring a material extraction rule of the mini app from a server, comprises:
acquiring the material extraction rule of the mini app from the server, based on a to-be-extracted material type and/or material extraction rule version information.

4. The method according to claim 1, wherein the material content of the new page comprises at least one of: a title of the new page, a description, a picture link, a tag, a video link, or interaction information.

5. The method according to claim 1, wherein the extracting a material content of the new page based on a material extraction rule of the mini app, comprises:
extracting the material content of the new page based on the material extraction rule of the mini app, via an asynchronous thread.

6. The method according to claim 1, wherein after extracting the material content of the new page, the method further comprises:
verifying the extracted material content to obtain a material content that meets a verification rule, based on the verification rule; and
rating the material content that meets the verification rule, to push a material based on a rating result.

7. An electronic device, comprising:
at least one processor; and
a memory communicatively connected to the at least one processor;
wherein the memory stores instructions executable by the at least one processor, and the instructions, when executed by the at least one processor, cause the at least one processor to perform operations, comprising:
detecting whether a mini app page is jumped to a new page of a business party of a mini app, during operation of the mini app; and
in response to the mini app page being jumped to the new page of the business party of the mini app, extracting a material content of the new page based on a material extraction rule of the mini app, for use as a new material content of the mini app.

8. The electronic device according to claim 7, wherein before the extracting a material content of the new page based on a material extraction rule of the mini app, the operations further comprise:
acquiring a material extraction rule of the mini app from a server, when the mini app starts; and
loading the acquired material extraction rule.

9. The electronic device according to claim 8, wherein the acquiring a material extraction rule of the mini app from a server, comprises:
acquiring the material extraction rule of the mini app from the server, based on a to-be-extracted material type and/or material extraction rule version information.

10. The electronic device according to claim 7, wherein the material content of the new page comprises at least one of: a title of the new page, a description, a picture link, a tag, a video link, or interaction information.

11. The electronic device according to claim 7, wherein the extracting a material content of the new page based on a material extraction rule of the mini app, comprises:
extracting the material content of the new page based on the material extraction rule of the mini app, via an asynchronous thread.

12. The electronic device according to claim 7, wherein after extracting the material content of the new page, the operations further comprise:
verifying the extracted material content to obtain a material content that meets a verification rule, based on the verification rule; and
rating the material content that meets the verification rule, to push a material based on a rating result.

13. A non-transitory computer readable storage medium, storing computer instructions, wherein the computer instructions, when executed by the a processor, cause the processor to perform operations, comprising:
detecting whether a mini app page is jumped to a new page of a business party of a mini app, during operation of the mini app; and
in response to the mini app page being jumped to the new page of the business party of the mini app, extracting a material content of the new page based on a material extraction rule of the mini app, for use as a new material content of the mini app.

14. The non-transitory computer readable storage medium according to claim 13, wherein before the extracting a material content of the new page based on a material extraction rule of the mini app, the operations further comprise:
acquiring a material extraction rule of the mini app from a server, when the mini app starts; and
loading the acquired material extraction rule.

15. The non-transitory computer readable storage medium according to claim 14, wherein the acquiring a material extraction rule of the mini app from a server, comprises:
acquiring the material extraction rule of the mini app from the server, based on a to-be-extracted material type and/or material extraction rule version information.

16. The non-transitory computer readable storage medium according to claim 13, wherein the material content of the new page comprises at least one of: a title of the new page, a description, a picture link, a tag, a video link, or interaction information.

17. The non-transitory computer readable storage medium according to claim 13, wherein the extracting a material content of the new page based on a material extraction rule of the mini app, comprises:
extracting the material content of the new page based on the material extraction rule of the mini app, via an asynchronous thread.

18. The non-transitory computer readable storage medium according to claim 13, wherein after extracting the material content of the new page, the operations further comprise:
verifying the extracted material content to obtain a material content that meets a verification rule, based on the verification rule; and
rating the material content that meets the verification rule, to push a material based on a rating result.
